(19) United States
(12) Patent Application Publication
(10) Pub. No.: US 2005/0068299 A1
(43) Pub. Date: Mar. 31, 2005

(54) Two-dimensional coordinate signal input apparatus

(75) Inventor: Steve Ore-Yang, Taipei (TW)

Correspondence Address: EDWARDS & ANGELL, LLP, P.O. BOX 55874, BOSTON, MA, 02205, US

(73) Assignee: Acrox Technologies Co., Ltd.

(21) Appl. No.: 10/917,247

(22) Filed: Aug. 11, 2004

Related U.S. Application Data
(63) Continuation-in-part of application No. 10/000,629, filed on Oct. 31, 2001, now abandoned.

(30) Foreign Application Priority Data
Jan. 15, 2001 (TW) 90200739
Jul. 11, 2001 (CN) 01231311.4

(51) Int. Cl. G09G 5/08

(52) U.S. Cl. 345/164

(57) ABSTRACT

A two-dimensional coordinate signal input apparatus includes a scrollball module and a microprocessor. In which, the scrollball module has a scrollball and at least two wheels in contact with the scrollball for revolving thereby, so that the scrollball module is capable of detecting a rolling movement of the scrollball and outputting a rolling signal in response to an impetus caused by a user. And the microprocessor has a scrollball program defining a two-dimensional coordinate system for receiving the rolling signal from the scrollball module and transforming the rolling signal into a two-dimensional control signal to control a scrolling movement of a scrollbar of an application program. The two-dimensional coordinate system has four zones so that when the scrollball moves toward a certain zone of the four zones, the scrollbar of the application program is moved toward a certain direction corresponding to the certain zone.

### FIELD OF THE INVENTION

The present invention is directed to a two-dimensional coordinate signal input apparatus for controlling the scrollbar of an application program run in a data processing unit. More particularly, the present invention is directed to a two-dimensional coordinate signal input apparatus which is integrable into an input hardware interface for use in the data processing unit.

### BACKGROUND OF THE INVENTION

At present, a computer mouse device has become an indispensable peripheral input means to an ordinary computer user. The operation of the common computer mouse device basically utilizes a light-emitting diode (LED) to emit lights, and generates flickering optical signals by permitting the lights to pass through the photo grid which is provided with a particular shadowing effect during the computer mouse device movement. The flickering optical signals are then converted by the photoelectric converting device into signals each having a phase difference, which are provided to be processed by the microprocessor of the computer mouse device to determine the moving direction and distance of the computer mouse device. Therefore, the moving direction and distance of the mouse device represent the direction and distance of the cursor on the screen of the computer.

Please refer to FIGS. 1(a) to 1(c). FIGS. 1(a) to 1(c) illustrate the scrollbar controlling steps of the conventional mouse. However, a movement control of a scrollbar of a conventional mouse has three steps: first, please refer to FIG. 1(a), moving the mouse 1 from the position 1 to the position 2 for moving the cursor 33 from the position 1′ to the position 2′ and atop a scrollbar Y of the application program 31, second, please refer to FIG. 1(b), continuously pressing (clicking) a key 10 of the mouse 1 by the finger 10′ for the cursor 33 to hold the scrollbar Y, and third, please refer to FIG. 1(c), moving the mouse 1 for dragging the scrollbar Y from the position 2 to the position 3. According to FIGS. 1(a) to 1(c), it is easy to feel troublesome, because this conventional scrolling mechanism needs three movements of hand: in FIG. 1(a), moving the mouse 1, in FIG. 1(b) pressing the key 10 continuously by one finger 10′, and in FIG. 1(c), moving the mouse 1 again. For example, during one uses a browser, which is also an application program, for browsing a webpage, when he wants to read the part outside the certain view of the browser's window, he must distract from the contents (of the webpage) to move his eyes for moving the cursor atop a scrollbar Y to drag it, and make the outside part to scroll, and then shown on the window. It is understood by referring FIGS. 1(a) to 1(c). However, because he has distracted from the contents, he must revisit that contents to find out where the continuation of the contents is read before. Therefore, it is clear that after several conventional scrollings, a user will gradually lose his patience. The efficiency of using an application program 31 is also decreased.

In prior art, the photo grid mounted in a typical computer mouse device for providing shadowing effect to generate flickering optical signals is generally embodied in dual wheels. FIG. 1(d) depicts a prior dual-wheel mouse device, in which one of the wheels (101,102) is responsible for providing the computer mouse device with the input signal along the X-axis for the scrollbar X, and the other wheel is responsible for providing the computer mouse device with the input signal along the Y-axis for the scrollbar Y. With respect to the practical moving direction and the displacement of the prior dual-wheel mouse device, it is resolved by the mechanism of the computer mouse device and the firmware program embedded therein.

Nonetheless, the computer mouse device using a single wheel or dual wheels as the two-dimensional coordinate signal input apparatus has some innate limitations, and is swore by the computer user for a long time. It is not intuitionally to use the dual wheels to scroll the scrollbar, because both of the dual wheels are scrolling back and forth. However, the scrollbar X is needed to be moved lateral. Furthermore, it is not easily to use two fingers to scroll the dual wheels individually and some interference would be caused therebetween, when the page of the application program is needed to be scrolled in a diagonal direction. More particularly, the operation of the dual wheels will offend against the ergonomics. Therefore, it is necessary to create a two-dimensional coordinate signal input apparatus for intuitionally controlling the scrollbar of an application program run in a data processing unit and without moving a cursor atop the scrollbar.

In view of the foregoing disadvantages of taking the conventional mouse as the two-dimensional coordinate signal input apparatus for controlling the scrollbar, there tends to provide an innovated two-dimensional coordinate signal input apparatus which employs a scrollball and is integrated into an input means for use in a data processing unit.

### SUMMARY OF THE INVENTION

It is, therefore, an object of the present invention is to provide a two-dimensional coordinate signal input apparatus, which employs a scrollball to provide two-dimensional control signals to control a movement of a scrollbar of an application program running on a data processing unit.

To this end, the present invention provides a two-dimensional coordinate signal input apparatus integratable into an input hardware interface for a data process unit. The two-dimensional coordinate signal input apparatus includes a scrollball module and a microprocessor. In which, the scrollball module has a scrollball and at least two wheels in contact with the scrollball for revolving thereby, so that the scrollball module is capable of detecting a rolling movement of the scrollball and outputting a rolling signal in response to an impetus caused by a user. And the microprocessor has a scrollball program defining a two-dimensional coordinate system for receiving the rolling signal from the scrollball module and transforming the rolling signal into a two-dimensional control signal to control a scrolling movement of a scrollbar of an application program. The two-dimensional coordinate system has four zones so that when the scrollball moves toward a certain zone of the four zones, the scrollbar of the application program is moved toward a certain direction corresponding to the certain zone.

In accordance with another aspect of the present invention, another two-dimensional coordinate signal input apparatus is provided. The twodimensional coordinate signal input apparatus includes a scrollball module having a scrollball and an optical sensor for detecting a rolling movement of the scrollball and outputting a rolling signal in response to an impetus caused by a user, and a microprocessor having a scrollball program defining a two-dimensional coordinate system for receiving the rolling signal from the scrollball module and transforming the rolling signal into a two-dimensional control signal to control a scrolling movement of a scrollbar of an application program. The two-dimensional coordinate system has at least four zones so that when the scrollball moves toward a certain zone of the four zones, the scrollbar of the application program is moved toward a certain direction corresponding to the certain zone.

Preferably, the four zones include upper zone, lower zone, right zone and left zone.

Preferably, the scrollball is formed from a marble.

Preferably, the scrollball is formed from a polished refined ball.

Preferably, the scrollball is formed by a resin injection molding process.

Preferably, the two-dimensional coordinate signal input apparatus is integratable into an input hardware interface for a data processing unit.

Preferably, the data processing unit is an image processing device.

Preferably, the input hardware interface is one selected from a group consisting of a computer mouse device, a keyboard, a digital camera and a scrollball input means.

Preferably, the data processing unit is a personal computer.

Now the foregoing and other features and advantages of the present invention will be more clearly understood through the following descriptions with reference to the accompanying drawings, in which:

### BRIEF DESCRIPTION OF THE DRAWINGS

FIG. 1(a) is a schematic view showing the operation of the scrollbar by the conventional mouse device;

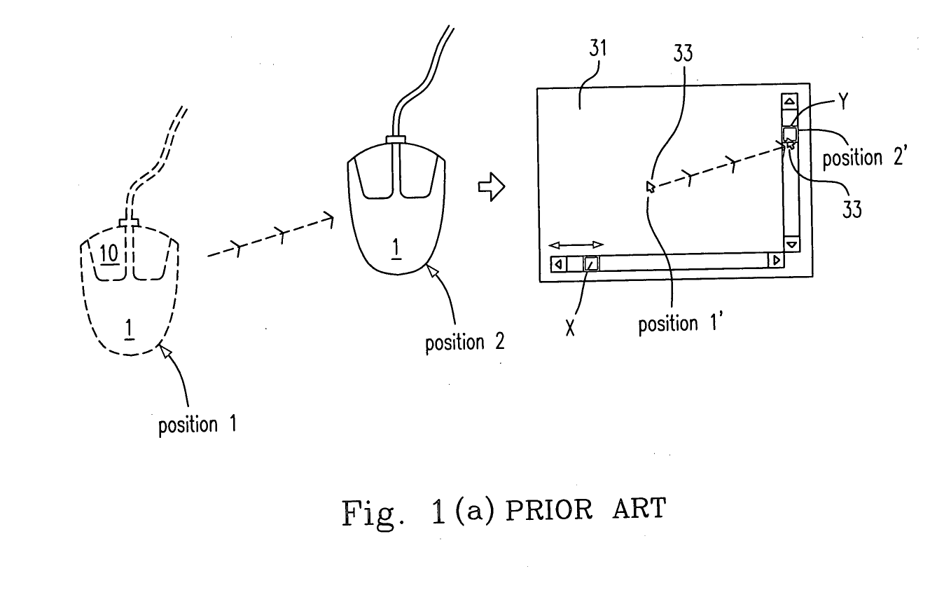

FIG. 1(b) is a schematic view showing the operation of the scrollbar by the conventional mouse device;

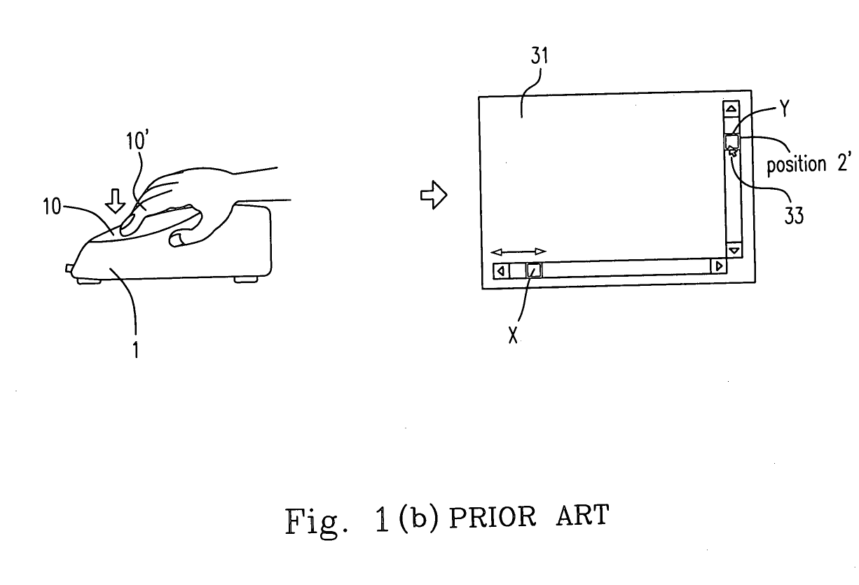

FIG. 1(c) is a schematic view showing the operation of the scrollbar by the conventional mouse device;

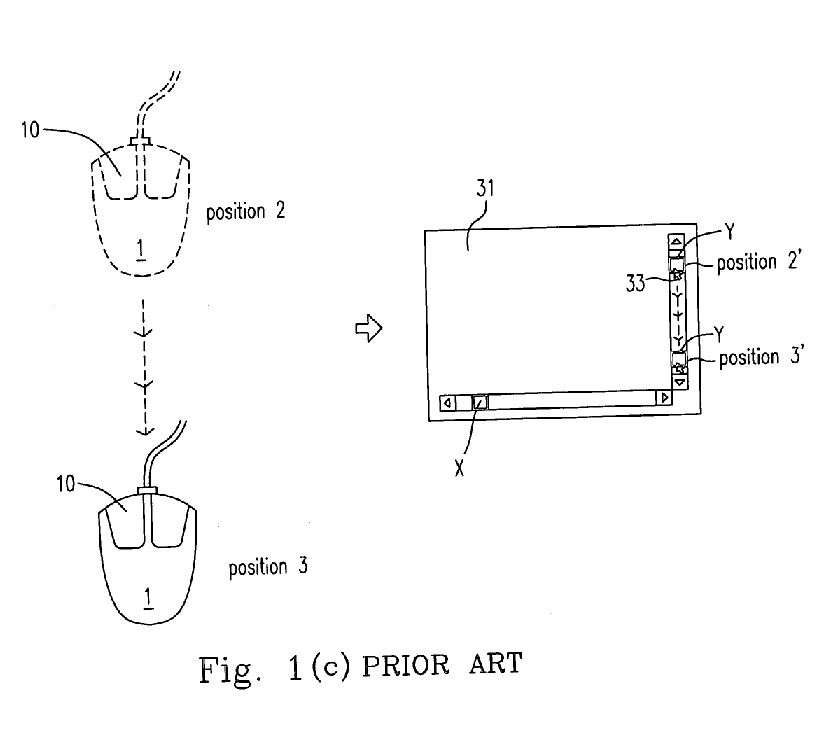

FIG. 1(d) is an exterior view of a prior dual-wheel mouse device;

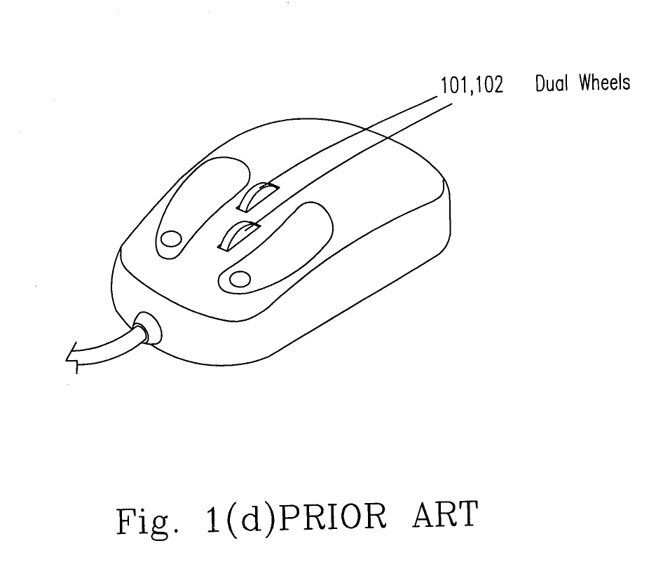

FIG. 2(a) is an exploded view of the computer mouse device with a built-in two-dimensional coordinate signal input apparatus in accordance with a preferred embodiment of the present invention;

FIG. 2(b) is a sectional view of the scrollball module including an optical scanner for scanning a movement of the scrollball thereof according another preferred embodiment of the present invention;

FIG. 3(a) schematically illustrates a functional block diagram of the two-dimensional scrollbar control apparatus according to a preferred embodiment of the present invention;

FIG. 3(b) is a schematic graph explicating a first type of interrelation between the moving direction of the scrollball and the moving direction of the scrollbar of an application program running on a data processing unit;

FIG. 3(c) is a schematic graph explicating a second type of interrelation between the moving direction of the scrollball and the scrollbar of an application program running on a data processing unit;

FIG. 4(a) is an outline view of a computer mouse device with a scrollball-implemented scrollbar control apparatus being integrated thereinto according to a first preferred embodiment of the present invention;

FIG. 4(b) is an outline view of a computer keyboard with a scrollball-implemented scrollbar control apparatus being integrated thereinto according to a second preferred embodiment of the present invention;

FIG. 4(c) is an outline view of a digital camera with a scrollball-implemented scrollbar control apparatus being integrated thereinto according to a third preferred embodiment of the present invention; and

FIG. 4(d) is an outline view of a scrollball input means 44 with the built-in scrollbar control function.

### DETAILED DESCRIPTION OF THE PREFERRED EMBODIMENT

The present invention will now be described more specifically with reference to the following embodiments. It is to be noted that the following descriptions of preferred embodiments of the invention are presented herein for purpose of illustration and description only; it is not intended to be exhaustive or to be limited to the precise form disclosed.

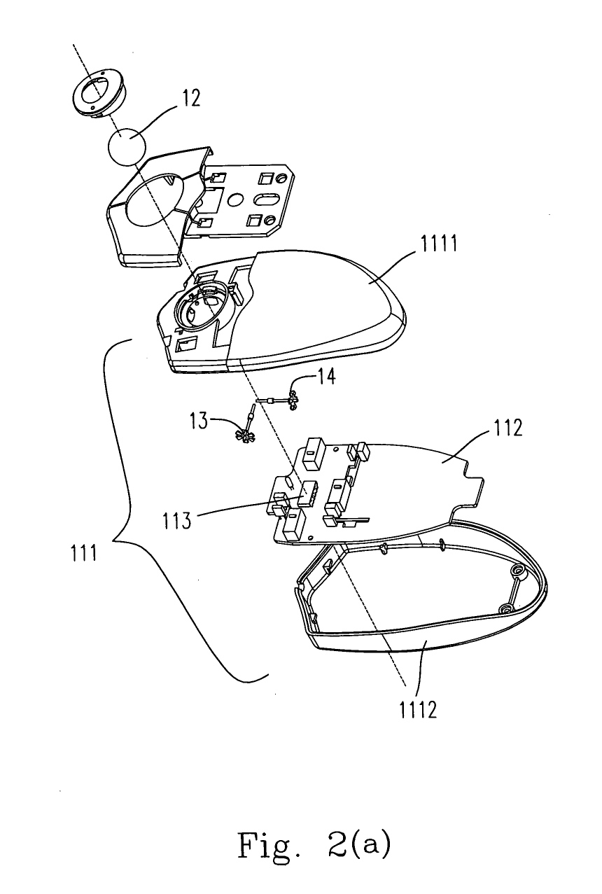

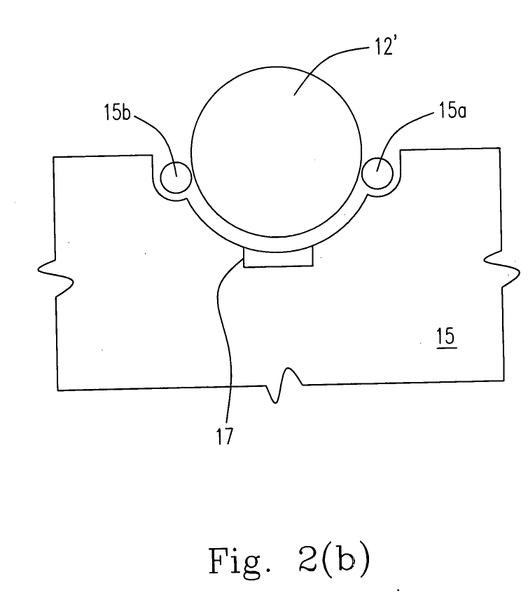

The two-dimensional coordinate signal input apparatus integrable into an input hardware interface according to the present invention will now be illustrated in detail by the following descriptions. Referring now to FIG. 2 (a), an embodiment of the present invention is illustrated. The embodiment of the present invention is to integrate the two-dimensional coordinate signal input apparatus into a computer mouse device including a computer mouse body with a housing 111. The housing 111 further includes a top cover 1111 and a base member 1112. The two-dimensional coordinate signal input apparatus for providing the computer mouse device with input signals of a two-dimensional coordinate system according to the present embodiment is implemented by a scrollball 12 and at least two wheels 13 and 14. Each of the wheels 13 and 14 has a side surface being in contact with the scrollball 12. Specifically, the scrollball 12 can be made up of a marble or a polished refined ball, and can be manufactured by a resin injection molding process. When a computer user rotates the scrollball 12, the wheels 13 and 14 will rotate with the scrollball 12, in which the wheel 13 is mated with the scrollball 12 to detect the movement of the scrollball 12 along a first axis of the two-dimensional coordinate system and provide the computer mouse device with input signals along the first axis, whereas the wheel 14 is mated with the scrollball 12 to detect the movement of the scrollball 12 along a second axis of the two-dimensional coordinate system and provide the computer mouse device with input signals along the second axis. The computer mouse device of FIG. 2 (a) further includes a circuit board 112 being positioned over the base member 1112 for permitting a control device including circuitry for processing the two-dimensional input signals generated by the wheels 13 and 14 to be mounted thereon. The aforementioned control device is directed to a microprocessor 113. The wheel 13 is employed to generate two input signals each has a phase difference, and the wheel 14 is also employed to generate two input signals each also has a phase difference. The microprocessor 113 is applied to receive and process the input signals generated by the wheels 13 and 14, and further the scrollball program as a firmware program embedded in the microprocessor 113 is capable of defining the two-dimensional coordinate system and determining the movement direction of the computer mouse device along each of the axes of the second two-dimensional coordinate system.

As that is well known in the art, the computer mouse device is dedicated to control the two-dimensional coordinate address of a cursor on a display screen. However, according to the present invention, the two-dimensional coordinate signal input apparatus is allowable to serve as a two-dimensional scrollbar control apparatus for supporting multifarious two-dimensional coordinate control functions for different application programs. Besides, in other embodiments, the control function for controlling the two-dimensional coordinate address of the scrollbars in an application program is further provided by the two-dimensional coordinate signal input apparatus of the present invention, and it is inclined to give detailed descriptions afterwards.

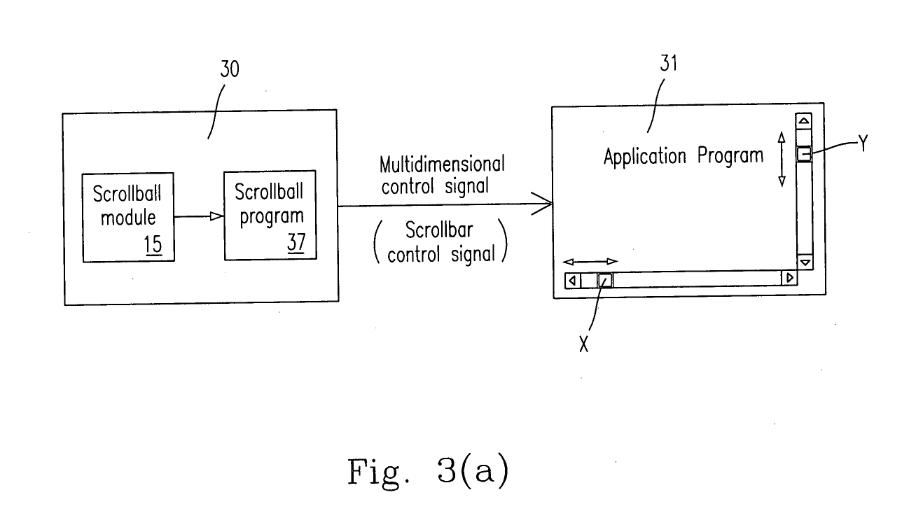

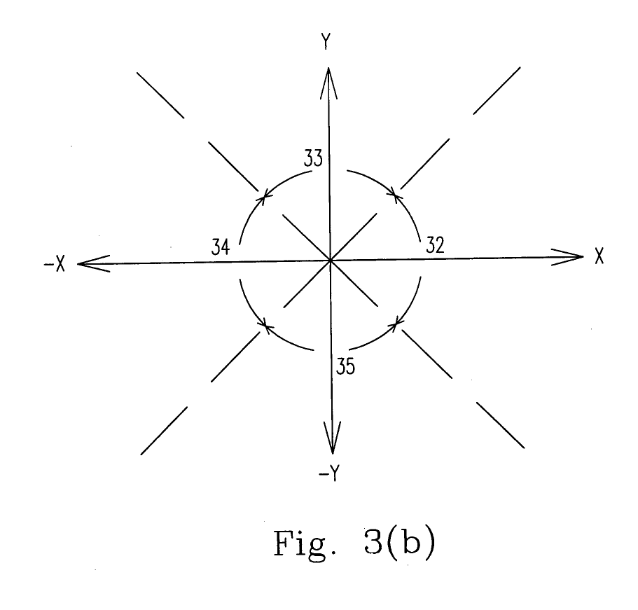

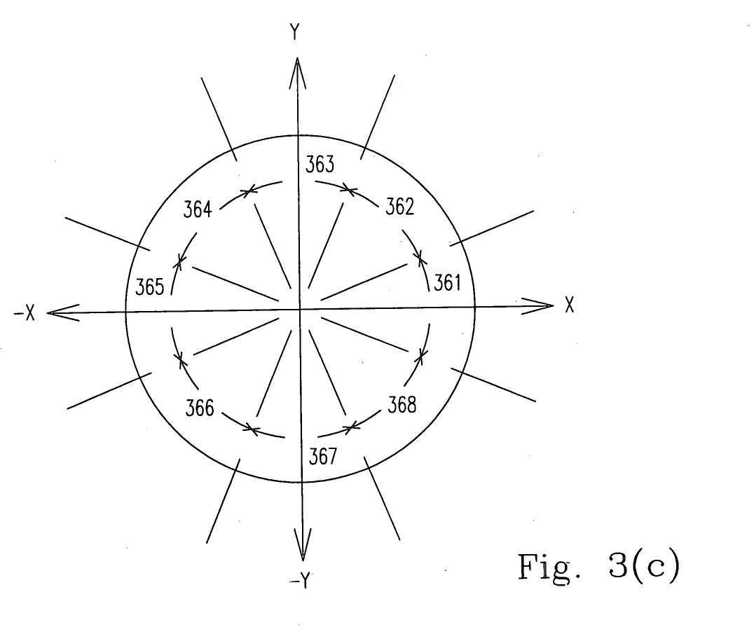

Please refer to FIG. 2 (b), which is the sectional view of the scrollball module including an optical scanner for scanning a movement of the scrollball thereof according another preferred embodiment of the present invention. The scrollball 12′ is supported by the roller 15a and the roller 15b to make the movement of the scrollball 12′ more smoothly. The scrollball module 15 has an optical sensor 17 to detect or scan the movement of the scrollball 12′ and output a rolling signal to the scrollball program 37 (FIG. 3(a)).

Please refer to FIG. 3(a). FIG. 3(a) schematically illustrates a functional block diagram of the two-dimensional scrollbar control apparatus according to a preferred embodiment of the present invention. The two-dimensional scrollbar control apparatus 30 has the scrollball module 15 for creating a rolling signal in response to an impetus caused by a user rolling the scrollball 12 (12′) (please refer to FIGS. 2(a) and 2(b)). And the apparatus 30 has a scrollball program 37 to receive the rolling signal from the scrollball module 15 and then the scrollball program 37 transforms the rolling signal into the two-dimensional control signal according to the two-dimensional coordinate system. Therefore, the two-dimensional control signal controls the scroll movements of the scrollbar X/scrollbar Y so as to control the application program 31 running on the data process unit, such as a personal computer. The two-dimensional control signal also is known as a scrollbar control signal.

Please further refer to the FIG. 3(b). FIG. 3(b) is a schematic graph explicating a first type of interrelation between the moving direction of the scrollball and the scrollbar of an application program running on a data processing unit. Please refer to FIGS. 3(a) and 3(b), the two-dimensional scrollbar control apparatus 30, which is formed by the scrollball module 15 and the scrollball program 37, is able to output a scrollbar control signal to an application program 31 running on a data processing unit having a display screen (not shown, such as a personal computer or an image processing device) for controlling the coordinate address (X-coordinate, Y-coordinate) of the scrollbar X/scrollbar Y of the application program 31. The interrelation between the moving direction of the scrollball and the moving direction of the scrollbars can be preferably understood by way of the chart of FIG. 3(b). It can be clearly seen from FIG. 3(b) that the two-dimensional coordinate plane is divided into zones 32, 33, 34 and 35. When the scrollball is moving toward a certain zone, the scrollbar corresponding to the zone that the scrollball is moving toward will be scrolled. For example, as the scrollball is moving toward zone 32, the X-axis scrollbar X of the application program will be scrolled toward right. The scroll movement of the other scrollbar can be deduced in an analogous manner. On the other hand, the interrelation between the moving direction of the scrollball and the moving direction of the scrollbars can further be defined in accordance with the requirements on the control mechanism. As shown in FIG. 3(c), the two-dimensional coordinate plane is divided into zones 361, 362, 363, 364, 365, 366, 367 and 368. Therefore, in addition to the scrollbar movement control functions of the X-axis scrollbar X and the Y-axis scrollbar Y of the application program along the up, down, left and right directions (which respectively corresponds to the scrollball movement toward zones 363, 367, 365 and 361), the scrollbar control apparatus of the present invention can additionally support the scrollbar movement control functions along other directions (for example: the diagonal direction, which respectively corresponds to the scrollball movement toward zones 362, 364, 366 and 368) for future application program interface design. For example, in FIG. 3 (c), because the zone 362 is between the zones 363 and 361, the scrolling movement in the zone 362 will be analyzed into the X-coordinate and Y-coordinate by the scrollball program 37. Therefore, while the scrollball 12 (12′) (please refer to FIGS. 2(a) and 2(b)) is rolled toward the zone 362, the scrollbar X is moved right and the scrollbar Y is moved up.

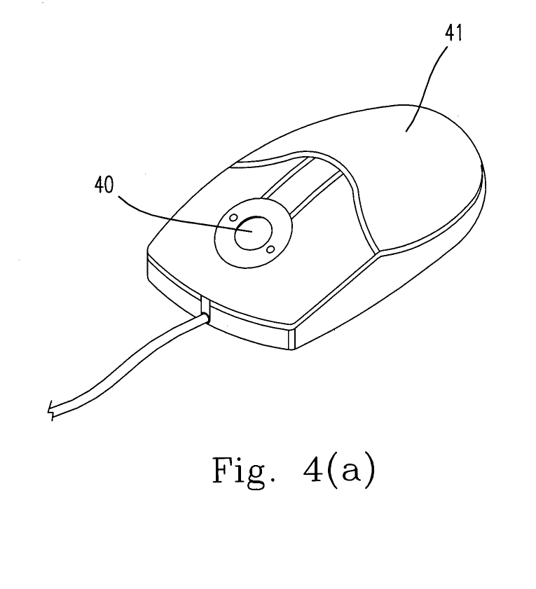

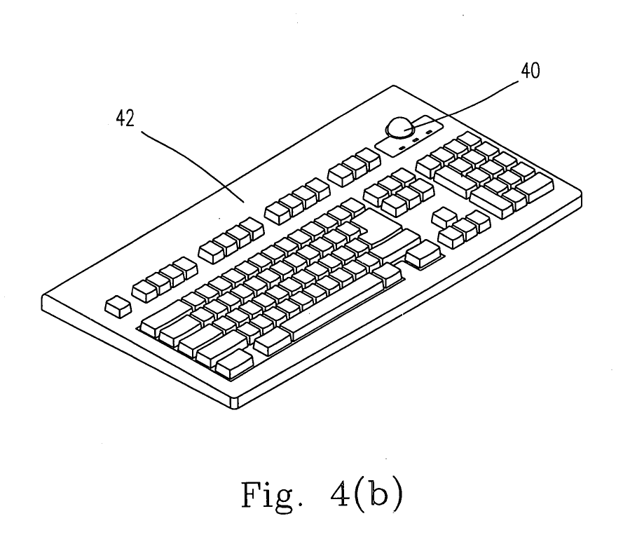

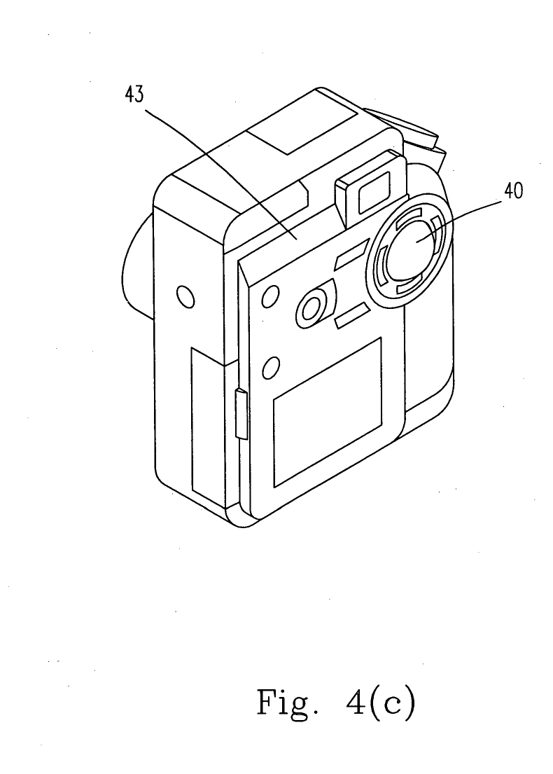

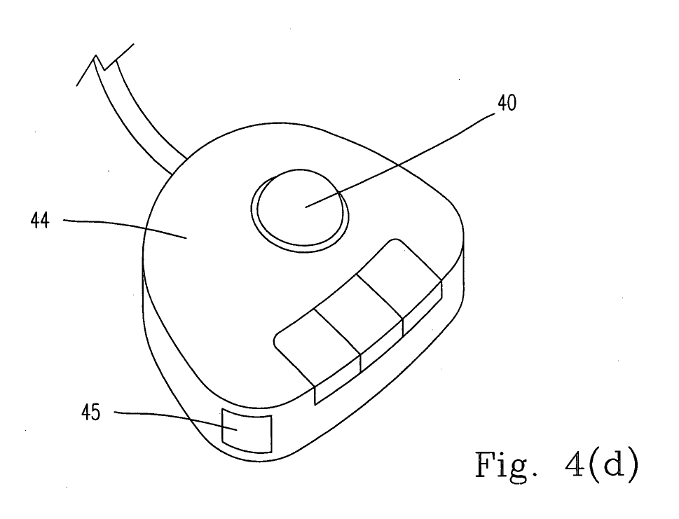

Turning to FIGS. 4(a) to 4(d), the preferred embodiments of the two-dimensional coordinate signal input apparatus 30 (FIG. 3a) being integrated into various input means are shown. FIG. 4(a) shows an outlined view of a computer mouse device 41 with a scrollball-implemented scrollbar control apparatus 40 being integrated thereinto. FIG. 4(b) shows an outlined view of a computer keyboard 42 with a scrollball-implemented scrollbar control apparatus 40 being integrated thereinto. FIG. 4(c) shows an outlined view of a digital camera 43 with a scrollball-implemented scrollbar control apparatus 40 being integrated thereinto, and FIG. 4(d) shows an outlined view of a scrollball input means 44 with the built-in scrollbar control function. In FIG. 4(d), the user only needs to press a function key 45 to switch control signals that the function key 45 is used to adjust the cursor location on the screen into the control signals for controlling the scrollbar movement of an application program. In a similar way, the scrollball-implemented scrollbar control apparatus as shown in FIGS. 4(a) to 4(c) can be designed to output the control signals for adjusting the cursor location or controlling the scrollbar movement. Certainly, the transmission between the input means with the built-in two-dimensional coordinate signal input apparatus and the data processing unit can be selected as in a wired form or in a wireless form as required.

It should be noted that the scrollball-implemented scrollbar control apparatus of the present invention can be made of a semi-optical mechanism as shown in FIG. 2 (a). On the other hand, it can be made of a pure optical mechanism as well as shown in FIG. 2 (b). Because the present apparatus is only for controlling the scrolling of the scrollbar, the present apparatus is unable to control the cursor.

The present invention substantially provides a two-dimensional coordinate signal input apparatus integrable into an input means for adjusting or controlling the scrollbar movement of an application program. Being compared to the prior dual-wheel-implemented apparatus, the scrollball-implemented apparatus of the present invention is more conformable and ergonomic to the user's requirements, and supports the intuitionally control function of the scrollbar movement of an application program. By way of combining the functions of scrollbar movement control into an input hardware interface and further integrating the input interface into an input means, a convenient and ingenious manipulative interface for controlling the scrollbar rolling has become feasible.

Furthermore, the appearance of the scrollball of the present invention is more attractive than the conventional one/dual-wheel-implement apparatus. Especially the pattern of the scrollball is more diversified than the wheel of the prior one/dual-wheel-implement apparatus. The scrollball can be made by transparent or semi-transparent material for the light being emitted therethrough. Or some particles can be blended into the transparent scrollball for reflecting the lights emitted to the transparent scrollball. Therefore, the scrollball is sparkling and colorful, and brings more fun to the user.

It is very clear that the only solution to overcome the matter of operational inconvenience for the current computer mouse device is to select a scrollball which is adapted for the human to manipulate the input data of the computer as the two-dimensional coordinate signal input apparatus, instead of using dual wheels on the conventional mouse device. Furthermore, only the X and Y coordinates of the mouse cursor address on the display screen require a high resolution, while the requirements imposed on the resolution of the other coordinates of the scrollbar movement on the display screen are set to be extremely low. Accordingly, the scrollball is considerably suitable for the design of the two-dimensional coordinate signal input apparatus for scrolling the scrollbar by the scrollball built on the computer mouse device.

While the invention has been disclosed in terms of what is presently considered to be the most practical and preferred embodiments, it is to be understood that the invention needs not to be limited to the disclosed embodiments. On the contrary, it is intended to cover various modifications and similar arrangements included within the spirit and scope of the appended claims which are to be accorded with the broadest interpretation so as to be accorded with the broadest interpretation so as to encompass all such modifications and similar structures.

1. A two-dimensional coordinate signal input apparatus integratable into an input hardware interface for a data process unit, comprising:
a scrollball module further having:
a scrollball; and
at least two wheels in contact with said scrollball for revolving thereby so as to detect a rolling movement of said scrollball and output a rolling signal in response to an impetus caused by a user; and
a microprocessor having a scrollball program defining a two-dimensional coordinate system for receiving said rolling signal from said scrollball module and transforming said rolling signal into a two-dimensional control signal to control a scrolling movement of a scrollbar of an application program, wherein said two-dimensional coordinate system has four zones so that when said scrollball moves toward a certain zone of said four zones, said scrollbar of said application program is moved toward a certain direction corresponding to said certain zone.

2. The two-dimensional coordinate signal input apparatus according to the claim 1, wherein said four zones includes upper zone, lower zone, right zone and left zone.

3. The apparatus as defined in claim 1, wherein said scrollball is formed from a marble.

4. The apparatus as defined in claim 1, wherein said scrollball is formed from a polished refined ball.

5. The apparatus as defined in claim 1, wherein said scrollball is formed by a resin injection molding process.

6. The apparatus as defined in claim 1, wherein said apparatus is integratable into an input hardware interface for a data processing unit.

7. The apparatus as defined in claim 6, wherein said data processing unit is an image processing device.

8. The apparatus as defined in claim 6, wherein said input hardware interface is one selected from a group consisting of a computer mouse device, a keyboard, a digital camera and a scrollball input means.

9. The apparatus as defined in claim 6, wherein said data processing unit is a personal computer.

10. A two-dimensional coordinate signal input apparatus, comprising:
a scrollball module further having:
a scrollball; and
an optical sensor for detecting a rolling movement of said scrollball and outputting a rolling signal in response to an impetus caused by a user; and
a microprocessor having a scrollball program defining a two-dimensional coordinate system for receiving said rolling signal from said scrollball module and transforming said rolling signal into a two-dimensional control signal to control a scrolling movement of a scrollbar of an application program, wherein said two-dimensional coordinate system has at least four zones so that when said scrollball moves toward a certain zone of said four zones, said scrollbar of said application program is moved toward a certain direction corresponding to said certain zone.

11. The two-dimensional coordinate signal input apparatus according to the claim 10, wherein said four zones includes upper zone, lower zone, right zone and left zone.

12. The apparatus as defined in claim 10, wherein said scrollball is formed from a marble.

13. The apparatus as defined in claim 10, wherein said scrollball is formed from a polished refined ball.

14. The apparatus as defined in claim 10, wherein said scrollball is formed by a resin injection molding process.

15. The apparatus as defined in claim 10, wherein said apparatus is integratable into an input hardware interface for a data processing unit.

16. The apparatus as defined in claim 15, wherein said data processing unit is an image processing device.

17. The apparatus as defined in claim 15, wherein said input hardware interface is one selected from a group consisting of a computer mouse device, a keyboard, a digital camera and a scrollball input means.

18. The apparatus as defined in claim 15, wherein said data processing unit is a personal computer.
